(19) United States
(12) Patent Application Publication
(10) Pub. No.: US 2013/0088039 A1
(43) Pub. Date: Apr. 11, 2013

(54) FAIRING WITH VORTEX GENERATORS

(71) Applicants: Robert Preston Feight, Duvall, WA (US); Alec C. Wong, Bellevue, WA (US)

(72) Inventors: Robert Preston Feight, Duvall, WA (US); Alec C. Wong, Bellevue, WA (US)

(73) Assignee: PACCAR Inc, Bellevue, WA (US)

(21) Appl. No.: 13/253,750

(22) Filed: Oct. 5, 2011

(51) Int. Cl. B62D 35/00; B62D 37/02

(52) U.S. Cl. 296/180.2; 296/180.1

(57) ABSTRACT

Fairings described herein aim to direct air streams into a gap formed between first a vehicle and a trailing vehicle, such as in a tractor-trailer combination, to reduce low pressure wake regions near the rear surface of the first vehicle thereby reducing drag forces on the vehicles. One or more embodiments of the fairings disclosed herein further aim to accelerate air streams such that the air streams travel quickly across the gap thereby reducing pressure forces on a front surface of a trailing vehicle. In some embodiments, the angle of the fairing relative to a surface of the vehicle is adjustable.

### BACKGROUND

Numerous means have been sought to improve the fuel efficiency of vehicles, particularly in tractor-trailer combinations. Even small improvements in fuel efficiency can significantly reduce annual operating costs. It is well known that reducing drag forces on tractor-trailer combinations is advantageous for increasing the aerodynamic properties of the combination, which in turn, improves the fuel efficiency of the combination.

Generally described, tractor-trailer combinations 18 typically include a tractor 20 having a so-called fifth wheel by which a box-like semi-trailer 24 may be attached to the tractor 20 by an articulated connection for transportation of the semi-trailer 24, as shown in FIG. 1. By providing the articulated connection between the tractor 20 and the semi-trailer 24, a space or gap 28 is formed therebetween. In general, the gap 28 is defined by a rear panel 32 of the tractor 20 and a front panel 44 of the semi-trailer 24. It is well known that this gap 28, or the gap between succeeding trailers (not shown) of tractor-trailer combinations tend to trap air thereby creating low-pressure wake regions and, as a result, creates drag forces.

Air deflectors or fairings have been utilized in the past for attempting to deflect air across the gap 28 between tractors 20 and semi-trailers 24. Although these fairing designs may have been successful in decreasing aerodynamic drag forces, there is a continuing need for improved designs to further reduce drag forces.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with aspects of the present disclosure, a fairing for use on a vehicle is provided. The fairing may include a substantially planar first section having outer and inner surfaces and a curved second section extending from the substantially planar first section. The fairing may further include at least one vortex generator disposed on the outer surface of the substantially planar first section.

In accordance with aspects of the present disclosure, a vehicle comprising a top surface and a rear surface. The vehicle may further include a fairing secured to the rear surface or the top surface. The fairing may include a substantially planar first portion having first and second opposing surfaces extending from a first edge, a plurality of vortex generators disposed on the first surface proximate the first edge, and a second portion extending from the first portion. The second portion may be curved relative to the first portion. The second surface of the first portion may be spaced apart from the top surface of the vehicle, and the second portion may be spaced apart from the rear surface of the vehicle.

In accordance with aspects of the present disclosure, a method of reducing drag on a vehicle combination having a leading vehicle and a trailing vehicle that forms a gap therebetween is provided. The method may include energizing a flow of air over a top surface of the leading vehicle thereby minimizing air flow directed into a first portion of the gap, and directing a flow of air into a second portion of the gap, wherein the second portion of the gap is near a rear surface of the leading vehicle. In some embodiments, the first portion may be proximate the upper surface of the leading and trailing vehicles.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a side elevational view of a conventional tractor-trailer combination in accordance with the prior art;

FIG. 2 is a front isometric view of one example of a fairing in accordance with aspects of the present disclosure;

FIG. 3A is a partial front isometric view of a tractor having the fairing of FIG. 2 in a top mounted orientation in accordance with aspects of the present disclosure;

FIG. 3B is a partial rear isometric view of a tractor having the fairing of FIG. 2 in a bottom mounted orientation in accordance with aspects of the present disclosure;

FIG. 4 is a rear isometric view of another example of a fairing in accordance with aspects of the present disclosure;

FIG. 5A is a partial side elevation view of a tractor-trailer combination with the fairing of FIG. 2 top mounted on the tractor illustrating air streams in the gap in accordance with aspects of the present disclosure;

FIG. 5B is a partial side elevation view of a tractor-trailer combination illustrating air streams in the gap in accordance with the prior art.

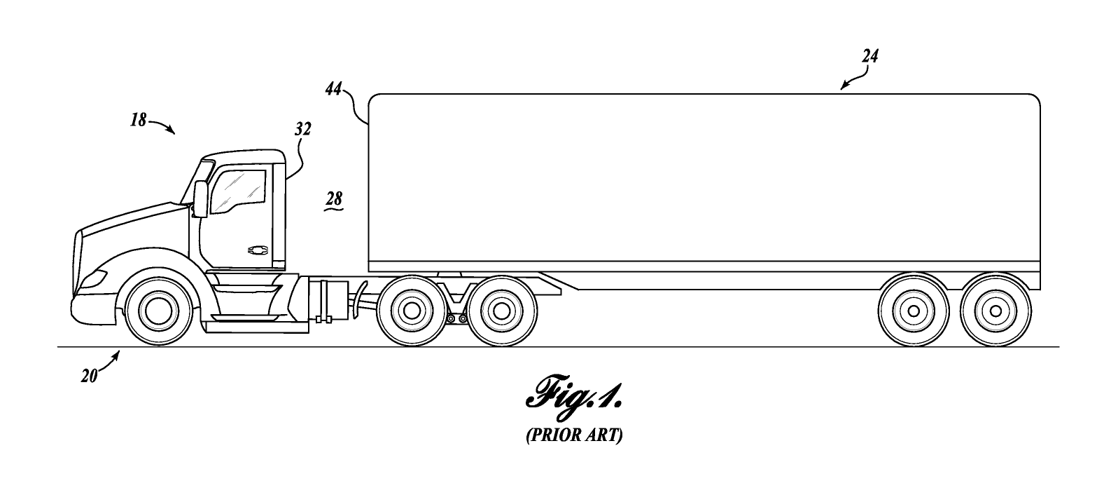

### DETAILED DESCRIPTION

The following discussion provides examples of fairings for use on vehicles, such as Class 8 trucks. Generally described, one or more embodiments of the present disclosure are directed to fairings that aim to direct air streams into a gap formed between a leading vehicle and a trailing vehicle, such as in a tractor-trailer combination, in order to reduce low pressure wake regions near the rear surface of the leading vehicle thereby reducing drag forces on the vehicles. Furthermore, one or more embodiments of the fairings disclosed herein aim to energize and thus, accelerate the air streams as well as delay flow separation from the leading vehicle. As a result, the air streams travel across the gap, thereby reducing pressure forces on a front surface of the trailing vehicle, such as the front panel of a trailer in a tractor-trailer combination. Additionally, one or more embodiments of the fairings disclosed herein are adjustable to direct air streams over the front panel of the trailing vehicle.

Although the fairings may be described in reference to heavy duty trucks, such as Class 8 vehicles, it should be appreciated that aspects of the present disclosure have wide application, and therefore, may be suitable for use with many types of vehicles that may be used to pull a trailing vehicle, such as a nonpowered vehicle, thereby forming a gap therebetween. Such vehicles may include passenger vehicles, buses, commercial vehicles, light and medium duty trucks, etc. Trailing vehicles may include passenger vehicles, buses, etc. as well, but may also include nonpowered vehicles, such as trailers and the like. Accordingly, the following descriptions and illustrations herein should be considered illustrative in nature, and thus, not limiting the scope of the present disclosure.

While some embodiments have been illustrated and described, it will be appreciated that various changes can be made therein without departing from the spirit and scope of the disclosure. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Additionally, it will be appreciated that embodiments of the present disclosure may employ any combination of the features described herein.

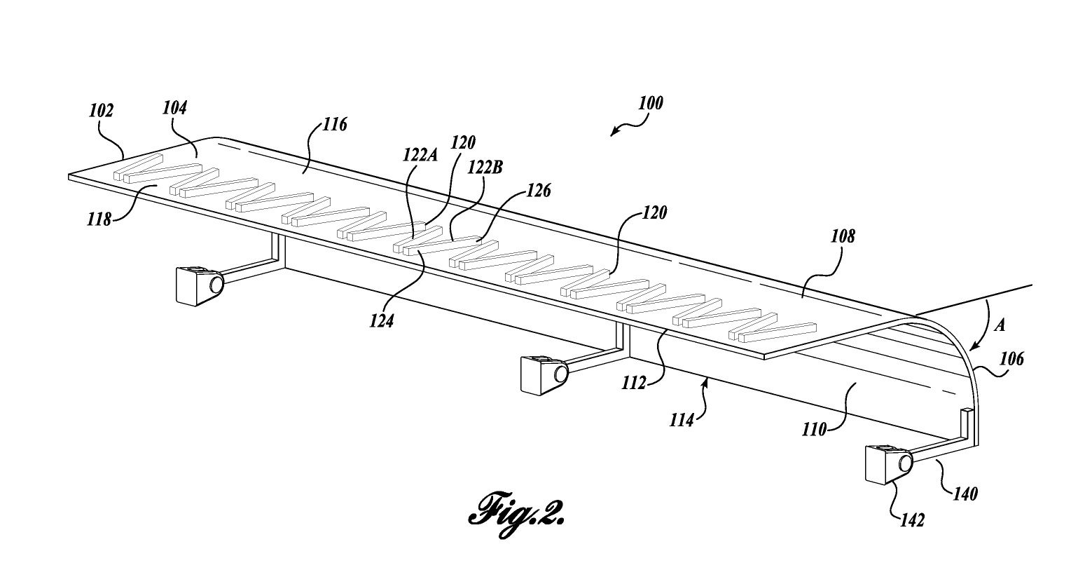

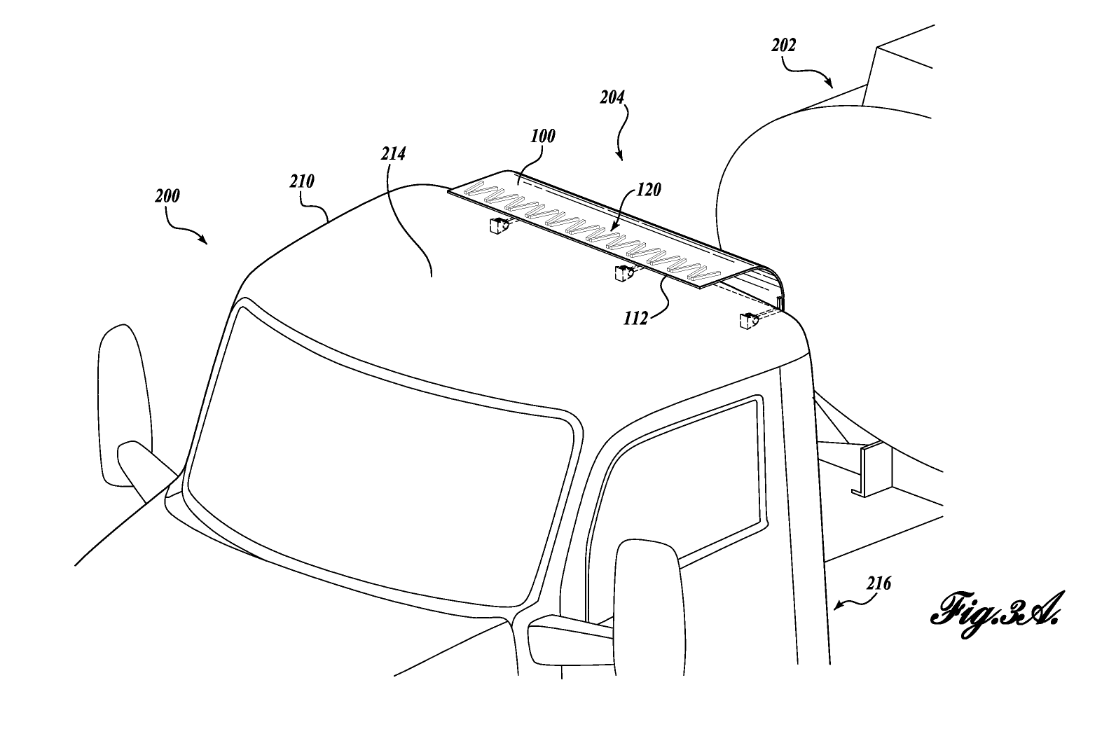

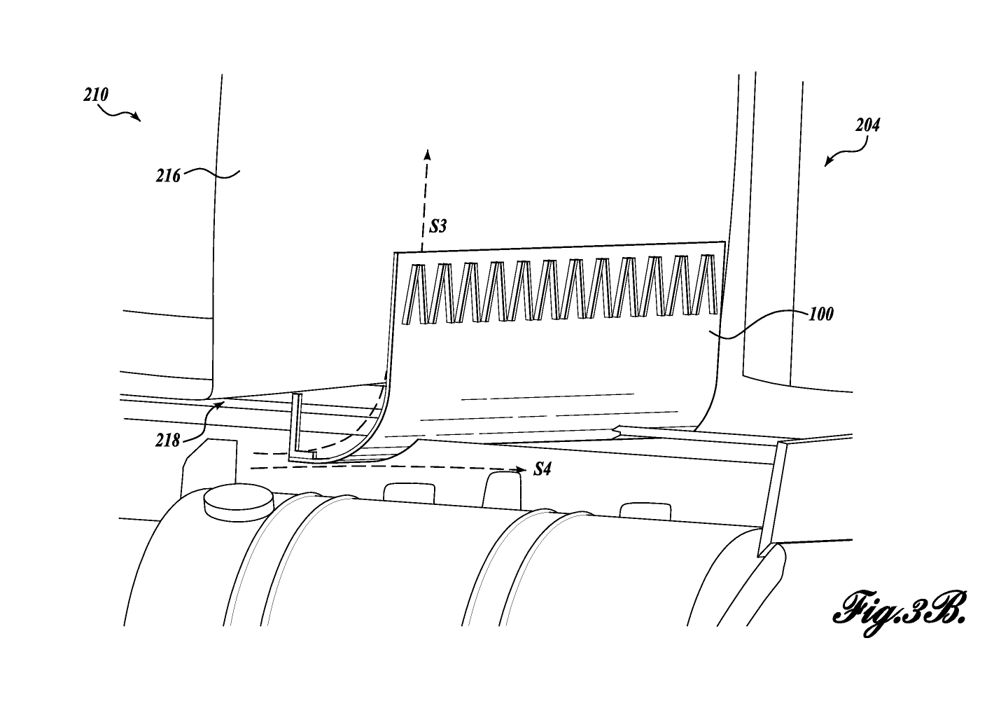

Turning now to FIG. 2, there is shown one embodiment of a fairing 100 in accordance with aspects of the present disclosure. In the illustrated embodiment, the fairing 100 include a plate-like body 102 having a substantially planar section 104 and curved section 106. The sections 104 and 106 of the body 102 define a contiguous outer surface 108 and an opposite inner surface 110 that extend between a first leading edge 112 and a second trailing edge 114. The fairing 100 further includes attachment arms 140 that may extend from the inner surface 110 of the body 102 as is illustrated in FIG. 2 or, alternatively, may extend from an edge, such as the second trailing edge 114. Each attachment arm 140 may include an attachment interface 142 configured to secure the fairing 100 to a cab assembly, such as a rear panel 216 of the cab assembly 210 in a top mounted orientation as is illustrated in FIG. 3A. As is shown in the embodiment of FIG. 2, the attachment interface 142 may include a pivotal member, such as a pin joint. In that regard, the fairing 100 may be pivotably mounted to the cab assembly 210 via attachment interface 142.

Still referring to FIG. 2, the curved section 106 of the fairing 100 is curved at an angle A relative to the planar section 104. Angle A may be any angle from approximately 30 degrees to approximately 90 degrees. As will be explained in more detail below, the curved section 106 of the fairing 100 is configured to direct air streams flowing proximate the inner surface 110 to behind the rear panel of the cab assembly thereby reducing low pressure wake regions. It is to be appreciated that the angle of curvature affects the amount of air flow that is directed behind the cab assembly in order to pressurize the low pressure wake regions located in the gap 204 (FIG. 3A). In general, a 90 degree curve directs more of the air stream to pressurize the low pressure wake regions behind the cab assembly 210 than a 30 degree curve does. Moreover, as will be explained in more detail below, the angle of curvature of the curved section 106 also affects the direction of air streams across the gap. For instance, smaller angles of curvature, such as 30 degree angles of curvature, delays flow separation from the outer surface 108. By delaying separation, the air stream tends to be directed more easily over a trailing vehicle, such as one having a height that is greater than or equal to the vehicle height in which the fairing 100 is installed.

Turning now to FIGS. 3A, there is shown a partial view of a tractor 200 and a trailer 202 separated from one another by a gap 204. Referring to both FIGS. 3A and 3B, the tractor 200 includes a cab assembly 210 having a chassis (not shown) surrounded, in part, by top panel 214, a rear panel 216, and a bottom panel 218. As is best illustrated in FIG. 3A, the fairing 100 may be mounted to the cab assembly 210 in a top mounted orientation by securing the attachment interfaces 142 to the rear panel 216. It is to be understood that a suitable mechanism for securing the attachment interfaces 142 to the rear panel 216 may be employed, including fasteners, adhesion, welding, or the like. When mounted, the fairing 100 is positioned such that the inner surface 110 of the planar section 104 and the curved section 106 is spaced apart from the top panel 214 and the rear panel 216, respectively, of the cab portion 210 of the tractor 200. As described above, in some embodiments, the fairing 100 is pivotally secured to the rear panel 216 such that the first leading edge 112 may be move towards or away from the top panel 214 of the cab assembly 210. In that regard, the planar section 104 of the fairing 100 may be positioned at an angle with the top panel 214 of the cab assembly.

In accordance with another aspect of the present disclosure, the fairing 100 may include at least one vortex generator 120 formed therein or thereon. Returning now to FIG. 2, the fairing 100 includes a plurality of vortex generators 120. The plurality of vortex generators 120 may be integrally formed with the planar section 104 or secured to the outer surface 108 of the planar section 104. In the embodiment shown, the vortex generators 120 may be disposed proximal the first leading edge 112. The vortex generators 120 may include any vortex generator configured to energize (i.e. accelerate) air streams across the outer surface 108 of the planar section 104 of the fairing 100.

The quantity of vortex generators 120 may vary depending on the amount of energy desired. That is, the quantity of vortex generators 120 may depend on the gap length between the tractor-trailer combination and/or the height differential between the trailer and the tractor. For longer gap lengths, the number of vortex generators 120 formed in the planar section 104 may be more than it is for shorter gap lengths. Likewise, for large height differentials, the number of vortex generators 120 formed in the planar section 104 may be more than it is for small height differentials.

As will be explained below, the shape of vortex generators 120 may also vary depending on the amount of energy desired. In the illustrated embodiment, each of the vortex generators 120 includes first and second elongate members 122A and 122B that are generally oriented in the direction of the air flow over the outer surface 108. Each of the first and second members 122A and 122B has a first end 124 proximate the first leading edge 112 and a second end 126. The first ends 124 of the first and second members 122A and 122B are spaced apart from each other by a distance forming a first opening, and the second ends 126 of the first and second members 122A and 122B are spaced apart from each other by a distance forming a second, larger opening. As such, each vortex generator 120 is generally V-shaped. In general, smaller first and/or second openings create higher energy levels. In that regard, smaller openings, particularly the first opening, may be used for larger gaps between the tractor and trailer. Similarly, the distance of the first opening relative to the distance of the second opening may be adjusted to effect the amount of energy required to deflect the air streams across the gap. In some embodiments, the distance of the second opening is about two to six times greater than the distance of the first opening, and in one embodiment it is four times greater than the distance of the first opening. In one embodiment, the distance of the first opening is approximately one inch, and the distance of the second opening is approximately four inches.

It is to be appreciated that the vortex generators 120 may be of a shape other than is shown in the illustrated embodiment of FIG. 2. For instance, in some embodiments, a portion of the vortex generators 120 are curved along the longitudinal axis of the vortex generator 120. In one embodiment, the center portion of the vortex generator 120 is curved. In that regard, the curved vortex generators may also reduce the effects of air streams moving in directions that are nonparallel with the motion of the vehicle, such as air streams caused by cross wind.

Positioned between the vortex generators 120 and the curved section 106 is a flow transition portion 116. The flow transition portion 116 of the outer surface 108 of the planar section 104 is configured to receive the energized air streams from the vortex generators 120. The flow transition portion 116 is substantially planar and may be configured to control or smooth out the air streams received from the vortex generators 120. In that regard, the flow transition portion 116 delays flow separation from the outer surface 108. In particular, the combination of the energized fluid flow generated by the vortex generators 120 and the fluid control by the flow transition portion 116 attempts to direct the air streams over the gap, such as gap 204 shown in FIG. 3A, rather than into the gap. As a result, the pressure forces applied to a front panel of a trailing vehicle, such as a trailer, are thereby reduced.

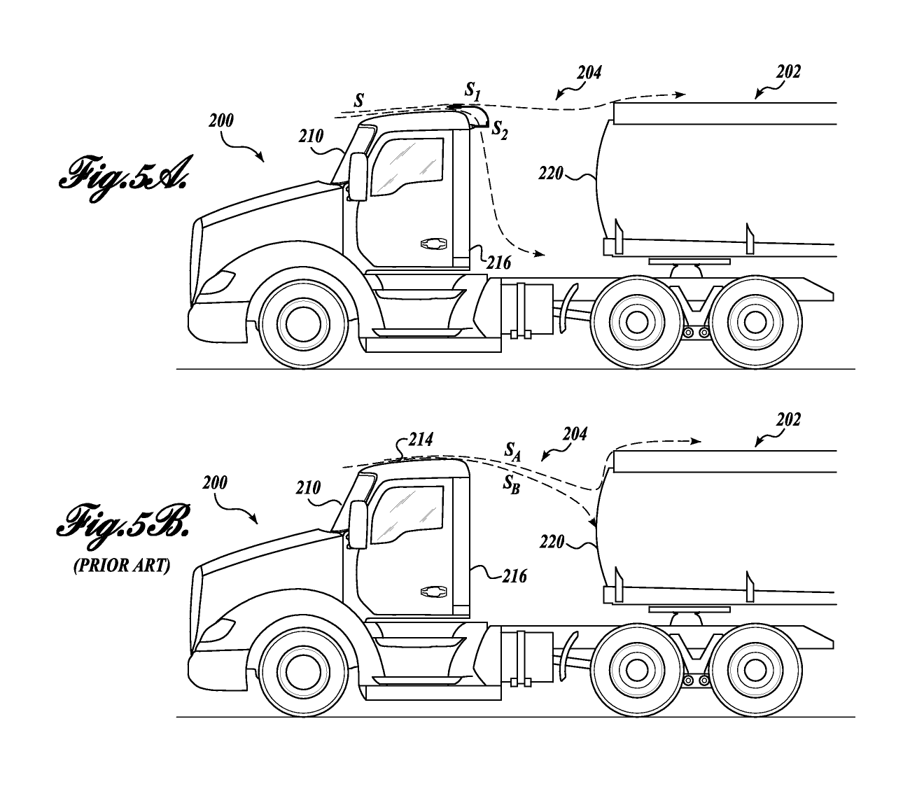

The operational effects of the fairing 100 installed on a vehicle will now be described in reference to FIG. 5A. Initially, however, the effects of air streams on a convention tractor-trailer combination (i.e. one that does not include a fairing of the present disclosure installed thereon) will first be described in reference to FIG. 5B. During operation, as a conventional tractor-trailer combination moves in a forward direction, the tractor-trailer combination encounters a plurality of air streams, including air streams S_{A} and S_{B}, across the top panel 214 of the cab assembly 210 of the tractor 200. Although only two air streams S_{A} and S_{B} are shown it should be appreciated that many more air streams are present. The air streams S_{A} and S_{B} proceed across the top panel 214 towards the gap 204. As the air streams S_{A} and S_{B} move across the gap 204, areas of low pressure develop in the gap 204 by the separation of air flow of the air streams from the top surface of the cab 214. The separation of air streams S_{A} and S_{B} forms a low pressure wake region located aft the rear panel 216 of the cab assembly 210, resulting in increased drag against the combination. Furthermore, as the air streams S_{A} and S_{B} enter the gap 204 in the opposite direction of the motion in which the combination is traveling, the air streams S_{A} and S_{B} apply a force against a front panel 220 of the trailer 202 thereby increasing drag forces against the combination.

The operational effects of the fairing 100 installed on a vehicle in a top mounted orientation will now be described in reference to FIG. 5A. Turning now to FIG. 5A, when a plurality of air streams S approaches the first leading edge 112 of the planar section 104 of the fairing 100, the air streams S separate such that a first air stream S₁ flows along the outer surface 108 of the planar section 104 and a second air stream S₂ flows along the lower surface 110. Although only two air streams are shown, S₁ and S₂, it should be appreciated that many air streams are present. As indicated above, the first air stream S₁ flows along the outer surface 108 of the fairing 100 and is energized as it passes through the plurality of vortex generators 120. The energized or accelerated first air stream S₁ then travels along the flow transition portion 116 of the fairing 100, which controls the air stream S₁ and delays separation of the air flow of the air stream S₁ from the outer surface 108. In that regard, the air stream S₁ travels across the gap 204, reducing pressure to the front panel 220 of the trailer 202.

The second air stream S₂ that flows along the inner surface 110 of the planar section 104 of the fairing 100 is directed into the gap 204, for minimizing or eliminating the low pressure wake regions along the rear panel 216 of the cab portion 210 of the tractor 200. In particular, the second air streams S₂ flows downwardly into the gap 204 thereby pressurizing the region aft of the rear panel 216 of the cab assembly 210. By increasing the pressure along the rear panel 216, the fairing 100 decreases drag forces on the combination. It is to be appreciated that the mass flow rate of air streams directed into the gap 204 may be adjusted by adjusting the height and width of the fairing 100. In particular, as the height and width of the fairing increase, the mass flow rate of the air streams directed into the gap 204 also increase.

As indicated above, the angle of orientation of the fairing 100 mounted on a cab assembly may be adjusted. In that regard, when the fairing 100 is installed on a vehicle in a top mounted orientation, the outer surface 108 of the planar section 104 may be oriented at an angle with the top panel 214 of the cab assembly 210. For instance, in one embodiment, the fairing 100 may be rotated in a manner such that the inner surface 110 of the planar section 104 is closer to the top panel 214 of the cab assembly 210 proximate the first leading edge 112 of the fairing 100 than it is proximate the curved section 106. In that regard, during operation of a vehicle, the air streams that flow along the outer surface 108 of the planar section 104 are directed in the same direction as the inclined planar section 104. This may be useful for tractor-trailer combinations in which the trailer is substantially taller than the tractor, such as greater than 4 inches taller.

Turning now to FIG. 3B, there is shown a fairing 100 attached to the cab assembly 210 in a bottom mounted orientation. In this bottom orientation, the second trailing edge 114 of the fairing 100 is positioned as the “leading edge” and causes air streams to separate, directing a first air stream S₃ along the inner surface 110 of the fairing 100 to pressurize the low pressure wake regions near the rear panel 216 of the cab assembly 210 and directing a second air stream S₄ along the outer surface 108 of the fairing 100 and across the gap 204 and below the trailer.

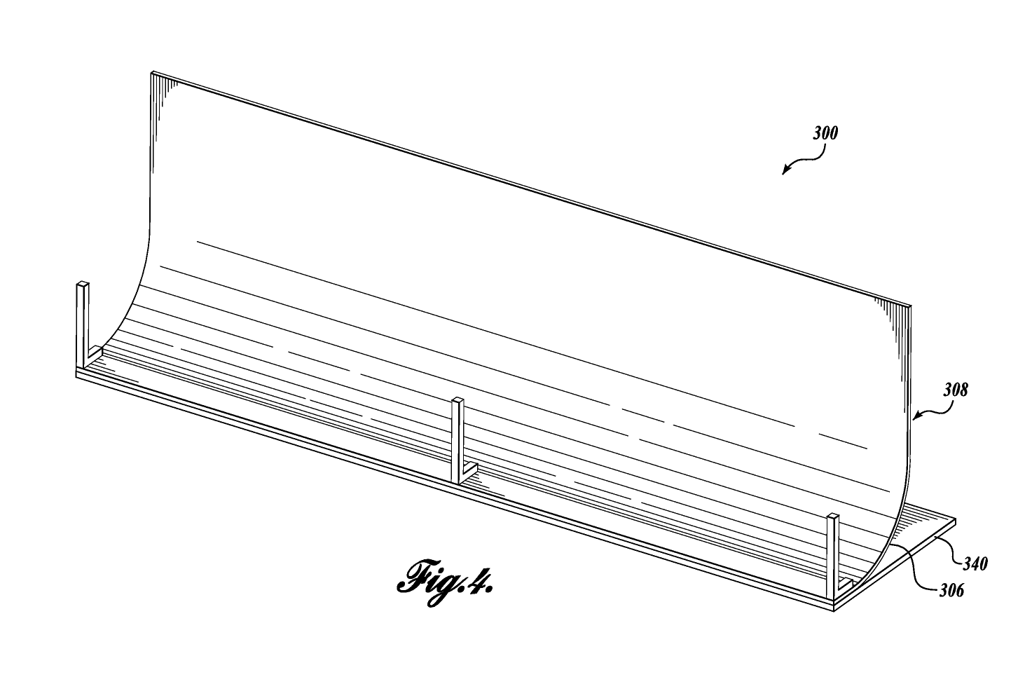

FIG. 4 is another example of a fairing 300 formed in accordance with aspects of the present disclosure. The fairing 300 is substantially identical in construction and operation as the fairing 100 of FIG. 2, except for the differences will be described in greater detail below. For clarity in the ensuing descriptions, numeral references of like elements of the fairing 100 are similar, but in the 300 series for the illustrated embodiment.

The fairing 300 may be bottom mounted to a cab assembly 210 in a similar orientation as the fairing 100 is bottom mounted in FIG. 3B. As best shown in FIG. 4, the fairing 300 further includes a substantially planar member 340 secured to or positioned adjacent, for example, an outer surface 308 of the fairing 300 proximate the curved section 306. The planar member 340 may be configured to delay flow separation and to direct air streams across the gap 204 formed between the tractor 200 and the trailer 202, such as those shown in FIG. 3B. It should be appreciated that in one embodiment, the substantially flat member 340 may also include a plurality of vortex generators (not shown) formed in or on the outer surface 308 thereof as is described above in reference to FIGS. 2, to accelerate the air stream flow across the gap 204.

Various principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

The embodiments of the invention in which an exclusive property or privilege is claimed are defined as follows:

1. A fairing for use on a vehicle, comprising:
a substantially planar first section having an outer surface and an inner surface;
a curved second section extending from the substantially planar first section; and
at least one vortex generator disposed on the outer surface of the substantially planar first section.

2. The fairing of claim 1, wherein the substantially planar section has a first edge, and wherein the at least one vortex generator is disposed proximate the first edge.

3. The fairing of claim 2, wherein the at least one vortex generator comprises a first member spaced apart from a second member, the first and second members having first and second ends, wherein the first ends of the first and second members are spaced apart at a first distance from each other and the second ends of the first and second members are spaced apart at a second distance from each other.

4. The fairing of claim 3, wherein the first ends of the first and second members are proximate the first edge.

5. The fairing of claim 4, wherein the second distance is four times greater than the first distance.

6. The fairing of claim 4, wherein the second distance is six times greater than the first distance.

7. The fairing of claim 2, wherein the first edge is a leading edge.

8. The fairing of claim 1, wherein the at least one vortex generator comprises a plurality of vortex generators.

9. The fairing of claim 8, wherein the substantially planar section includes a transition portion disposed between the plurality of vortex generators and the curved section.

10. The fairing of claim 1, wherein the curved section is curved relative to the substantially planar section at an angle from approximately 30 degrees to approximately 90 degrees.

11. The fairing of claim 1, further comprising at least one attachment interface configured to secure the fairing to the vehicle.

12. The fairing of claim 11, wherein the at least one attachment interface is configured to allow the fairing to rotate relative to a surface of the vehicle.

13. A vehicle, comprising:
a top surface;
a rear surface; and
a fairing secured to the rear surface or the top surface, wherein the fairing includes:
a substantially planar first portion having first and second opposing surfaces extending from a first edge;
a plurality of vortex generators disposed on the first surface proximate the first edge; and
a second portion extending from the first portion, wherein the second portion is curved relative to the first portion;
wherein the second surface of the first portion is spaced apart from the top surface of the vehicle, and wherein the second portion is spaced apart from the rear surface of the vehicle.

14. The vehicle of claim 13, wherein the second portion of the fairing curves relative to the first portion at an angle that is from approximately 30 degrees to approximately 90 degrees.

15. The vehicle of claim 14, wherein the second surface of the first portion is positioned parallel with the top surface of the vehicle.

16. The vehicle of claim 13, wherein the fairing is pivotally secured to the rear surface or the top surface of the vehicle.

17. The vehicle of claim 16, wherein the fairing is pivotally secured to the rear surface or the top surface of the vehicle such that second surface of the first portion may be adjusted between a number of angles relative to the top surface of the vehicle.

18. The vehicle of claim 13, wherein the first edge is a leading edge.

19. The vehicle of claim 13, wherein the fairing is secured to the rear surface and the first edge is a trailing edge.

20. A method of reducing drag on a vehicle combination having a leading vehicle and a trailing vehicle that forms a gap therebetween, the method comprising:
energizing a flow of air over a top surface of the leading vehicle thereby minimizing air flow directed into a first portion of the gap, wherein the first portion is proximate the upper surface of the leading and trailing vehicles; and
directing a flow of air into a second portion of the gap, wherein the second portion of the gap is near a rear surface of the leading vehicle.
